(19) United States
(12) Patent Application Publication
(10) Pub. No.: US 2019/0134945 A1
(43) Pub. Date: May 9, 2019

(54) REPLACEMENT OF METAL STAMPINGS WITH A MESH COMPONENT IN PLASTIC METAL HYBRID PART DESIGNS

(71) Applicant: Magna Exteriors Inc., Concord (CA)

(72) Inventor: Joel McPhee, Toronto (CA)

(21) Appl. No.: 16/098,639

(22) PCT Filed: May 5, 2017
(86) PCT No.: PCT/IB2017/052633

§ 371 Date: Nov. 2, 2018

Related U.S. Application Data
(60) Provisional application No. 62/332,781, filed on May 6, 2016.

(51) Int. Cl. B32B 7/08; B29C 45/14; B32B 7/022

(52) U.S. Cl. CPC B32B 7/08; B32B 7/022; B29C 45/14786; B29C 45/14311

(57) ABSTRACT

Plastic/mesh hybrid parts and method for manufacturing same, having at least one insert molded metal mesh component and plastic composite overmold. The metal mesh component replaces metal stampings. The mesh component is also a simpler, more cost effective solution and adds incremental stiffness over a plastic only section so design requirements are met.

### CROSS-REFERENCE TO RELATED APPLICATIONS

This application is a PCT International Patent Application claiming priority to U.S. Provisional Application No. 62/332,781, filed May 6, 2016. The disclosure of the above application is incorporated herein by reference.

### FIELD OF THE INVENTION

The present invention relates to an insert to assist in improved properties of a finished molded part and process for manufacturing same.

### BACKGROUND OF THE INVENTION

OEM Automotive customers are investigating light weight solutions for vehicle components and systems.

Therefore, there is a continuing need to identify lightweight, high strength materials and material processing technologies which can cost effectively reduce the weight of the vehicle while maintaining or improving functionality and durability. In particular, there exists a need for a lightweight reinforcement to assist in maintaining or improving properties such as functionality and mechanical properties of the final part.

Vehicle front end designs with multiple stampings have been replaced by plastic-metal-hybrid (PMH) parts. The purpose of the part is to support various front end components such as fascia, fender and headlamps and set up front end gaps and flush specifications. These parts reduce the overall weight of the vehicle and maintain functionality while reducing complexity and cost.

There are known PMH parts including the headlamp mounting crossmember (HMC) for vehicles, and grille opening reinforcements (GORs) for vehicles. One example of an HMC is a headlamp mounting crossmember stamping consisting of three metal stampings (crossmember stamping and RH/LH vertical strut stampings) overmolded with glass filled nylon, such as about 30% glass filled nylon. One example of a GOR consists of three metal stampings (crossmember stamping and RH/LH NVH stampings; “NVH” for noise/vibration/harshness requirements or performance/values) overmolded with glass filled nylon, such as 30% glass filled nylon. Another example of a GOR consists of eight metal stampings (upper crossmember stamping, lower brace stamping, RH/LH upper outrigger stampings, RH/LH lower outrigger stampings, and RH/LH side brace stampings) overmolded with glass filled nylon, such as 30% glass filled nylon.

Current PMH composites have the following advantages: insert molded stampings provide added stiffness and impact properties; and stampings provide robust attachment to vehicle and secondary components. However, there are several disadvantages, including, increased part weight, high cost of stampings, high cost of stamping transportation and storage (low pack density), increased cycle time (loading stampings into injection mold), and added complexity to locate stampings into the injection mold.

One attempt to overcome the aforementioned issues used an insert molded continuous fiber reinforced thermoplastic composite, which had the following advantages: Reduced weight over steel solutions; the secondary part can be produced using same resin as the overmold so that bonding occurs between both components; and increasing properties of the finished part. However, there are several disadvantages, including, that the insert molded part requires pre-heating before placement into the injection mold (longer cycle times, increased cost), the insert molded part requires pre-forming and trimming (increased cost), the final part may require post trimming (increased cycle time and increased cost), and there is no mechanical interlock of the insert molded part to overmold.

In order to further reduce overall weight and cost of known PMH parts, a proposed solution is to eliminate some of the metal stamping components and have only plastic in these areas. In the case of the HMC component above, the right hand (RH) and left hand (LH) vertical strut components could be eliminated and replaced with a plastic section leaving only the horizontal main crossmember. In the case of the second GOR above, the lower brace stamping could be eliminated. However, by just removing these metal stamping components, it is likely the overall part would not meet load requirements or minimum modal requirements. For example, the above first GOR's initial design solution does not have the RH/LH NVH stampings, but only has plastic sections with ribbing in these areas. The part cannot meet NVH requirements in the computer-aided engineering (CAE) analysis and the stampings components must be added in these areas.

In many cases the addition of stampings into the design in order to meet these minimum load or model requirements represents an over engineered design solution as there are no other cost effective alternatives besides plastic only or steel/plastic sections.

It is therefore desired to have a design solution for areas of the part which require additional stiffness in order to meet load requirements, but do not require the addition of a metal stamping.

### SUMMARY OF THE INVENTION

The present invention generally relates to a design solution that insert molds a steel mesh component, instead of a metal stamping. The mesh component is a simpler more cost effective solution and adds incremental stiffness over a plastic only section so the design requirements and predetermined properties are met.

The plastic/mesh hybrid assembly of the present invention includes a plastic composite overmold and insert molded mesh component. The plastic composite overmold provides the general mold shape of the part, overall properties of the final part, and provides attachment points to vehicles and secondary components. The insert molded mesh component adds stiffness and impact properties in areas with increased performance criteria and mechanically interlocks with the plastic overmold.

The present invention con improve overall weight, VOC emissions, and NVH values, e.g., by at least about 2 Hz.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1A is a front elevation of an insert molded mesh positioned on an outer layer of a finished part, in accordance with one embodiment of the present invention.

FIG. 1B is taken along A-A of FIG. 1A;

FIG. 2A is a front elevation of an insert molded mesh positioned on an inner layer of a finished part, in accordance with another embodiment of the present invention.

FIG. 2B is taken along A-A of FIG. 2A; and

FIG. 3 is a front elevation of an insert molded mesh part assembly, in accordance with an embodiment of the present invention.

### DETAILED DESCRIPTION OF THE PREFERRED EMBODIMENTS

The following description of the preferred embodiment(s) is merely exemplary in nature and is in no way intended to limit the invention, its application, or uses.

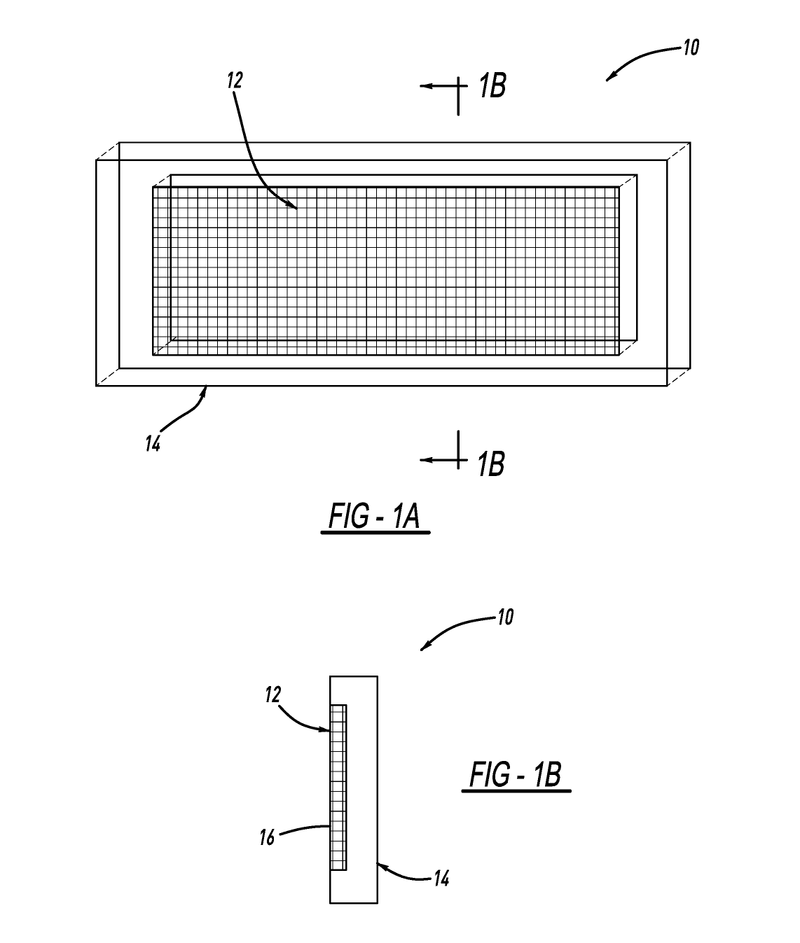

Referring to FIGS. 1-3 generally, the present invention is directed generally to a plastic/mesh hybrid assembly including a plastic composite overmold and insert molded mesh component. Typically, the present invention eliminates insert molded metal stampings. Preferably, the mesh is made of metal, most preferably, of steel.

The plastic composite overmold provides the general mold shape of the part, overall properties of the final part, and provides attachment points to vehicles and secondary components. The insert molded mesh component adds stiffness and impact properties in areas with increased performance criteria and mechanically interlocks with the plastic overmold.

According to an embodiment of the present invention, there is provided insert molding a metal mesh component, preferably of steel, instead of a metal stamping. The mesh component is a simpler more cost effective solution and adds incremental stiffness over a plastic only section so the design requirements could be met, e.g., load requirements, etc.

There are numerous variations of suitable mesh geometries which may be used dependant on the predetermined desired performance requirements in an overmolded plastic part. Mesh spacing represents the distance between parallel wires of the mesh. Various suitable mesh spacing may be used, including, but not limited to, such as commercially available grades of 4, 8 and 20 openings per inch. “Off count” mesh spacing which refers to mesh with different spacing in different directions is also contemplated without departing from the scope of the present invention. Any of various suitable gauge wire, e.g., progressively thicker gauge wire, may be used depending on the particular application, such as is determined for the effect on overall part performance. Many different types of mesh weave are also commercially available and may be used, depending on the particular applications, such as plain weave, lock crimp, intermediate crimp and twill weave. Welded mesh where the intersections are welded together may be used depending on the particular applications for increasing part performance. Weaved may be used depending on the particular applications. In addition to geometry variables, different grades of metal mesh along with alternate meshes made from plastics and any combinations thereof, may be used depending on the particular applications without departing from the scope of the present invention. In a preferred embodiment, the mesh is steel. Other variables such as mesh coatings and/or 3-dimensional mesh geometries may also be used depending on the particular applications without departing from the scope of the present invention.

In accordance with the present invention, there is provided (1) a lower cost to produce the insert molded mesh component over known steel solutions, (2) an insert molded mesh component that provides increased stiffness and impact properties in the finished molded part, (3) a mesh component that does not require a pre-forming operation (mesh can be loaded into the injection mold directly, and the mesh conforms to the injection mold shape), (4) a mesh and overmold mechanically interlocked in-mesh spacing during molding providing added increased properties in the finished part, (5) high pack density (lowered transportation costs), and (6) reduced complexity of locating the mesh to the injection mold. These are significant advantages over conventional systems.

In the present invention, the mesh geometry provides predetermined desired increased part stiffness (and any other part performance requirements) and the desired interaction with the overmolded plastic, depending on the particular applications. The overmolded metal mesh design results in increased properties over a plastic only design.

In an embodiment of the present invention, there is also provided a prototype tool for an overmolded mesh plastic part, having simplified part geometry such as a plaque shape with an overmolded flat sheet of steel mesh. The mesh component is manually located so that a variety of mesh geometries could be trailed. Alternatively, the mesh component is applied by automated location without departing from the scope of the present invention.

Referring more particularly to FIGS. 1A-1B, an insert molded mesh part for a plastic/mesh hybrid assembly is shown generally at 10, according to an embodiment of the present invention. The assembly 10 includes an insert molded mesh shown generally at 12 and an overmold shown generally at 14. The mesh 12 is positioned on an outer layer 16 of the finished part 10. FIG. 1B is a cross sectional view taken along A-A of FIG. 1A. Any alternative shape and geometries are contemplated depending on the application without departure from the scope of the present invention.

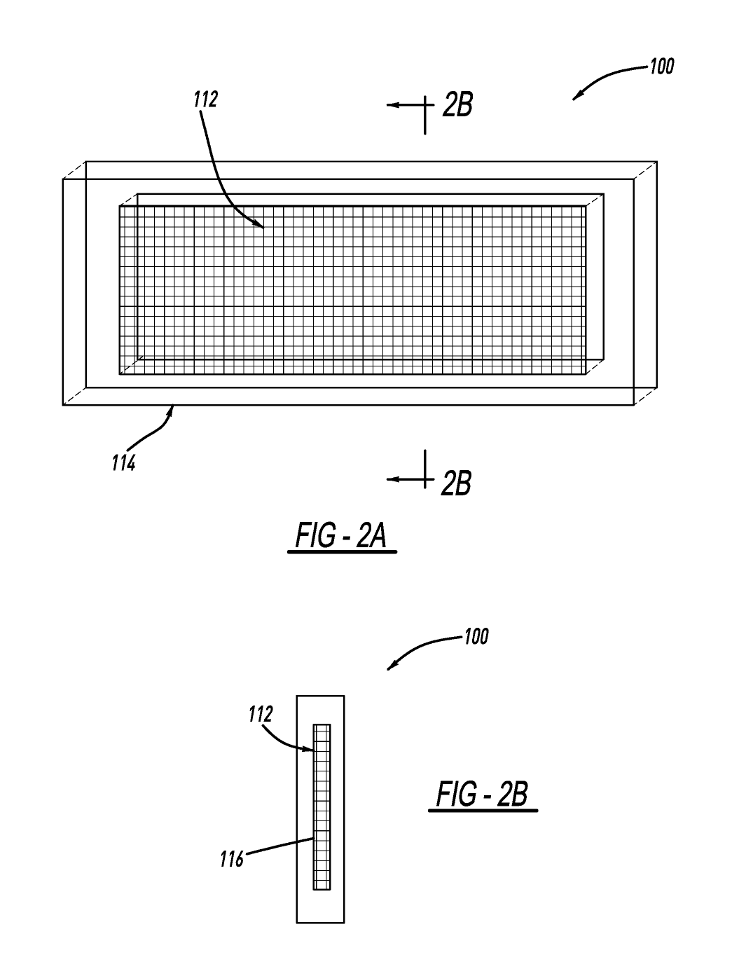

Referring more particularly to FIGS. 2A-2B, an insert molded mesh part for a plastic/mesh hybrid assembly is shown generally at 100, according to another embodiment of the present invention. The assembly 100 includes an insert molded mesh shown generally at 112 and an overmold shown generally at 114. The mesh 112 is positioned on an inner layer 116 of the finished part 100. Any alternative shape and geometries are contemplated depending on the application without departure from the scope of the present invention.

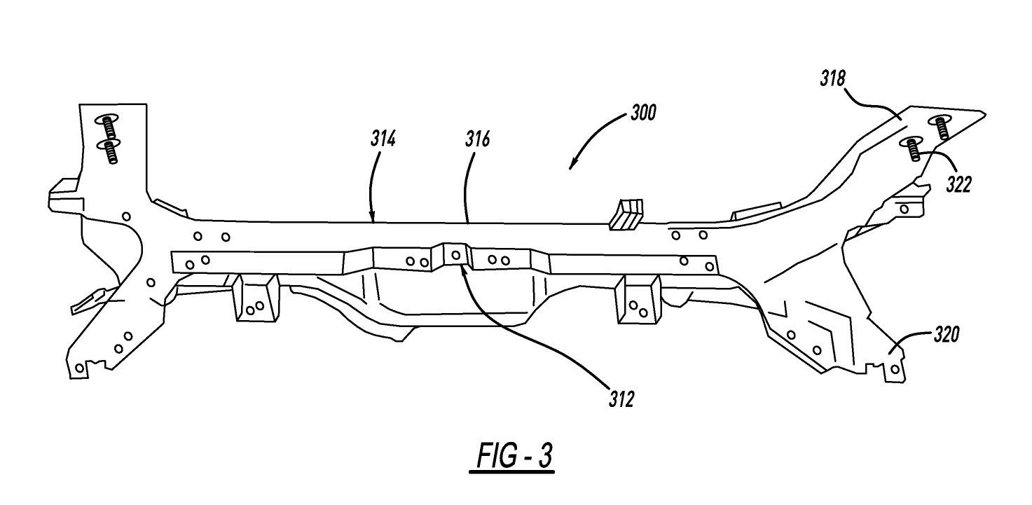

Referring more particularly to FIG. 3, a plastic/mesh hybrid assembly is shown generally at 300, according to an embodiment of the present invention. The assembly 300 includes an insert molded mesh portion shown generally at 312, e.g., metal mesh, and an overmold portion shown generally at 314, e.g, plastic composite overmold. The overmold portion 314 provides the general mold shape of the part 300, provides the overall properties of the final part 300, and provides at least one attachment point to the vehicle or secondary components. The insert molded mesh portion 312 adds stiffness and impact properties in areas with increased performance criteria and operably mechanically interlocks with the plastic overmold. The mesh portion 312 is positioned or inset on the outer layer of the assembly 300, inside the assembly 300, or in any other location suitable for meeting predetermined requirements.

The mesh spacing of the insert molded mesh portion 312 is generally about 4 to 20, preferably, 4-8. Preferably, the mesh material of the insert molded mesh portion 312 is steel.

For plastic metal composite part designs where the properties of a steel insert are not fully required, the overmolded mesh component in accordance with the present invention provides increased stiffness and impact properties in the finished molded part over composite only solutions. In addition, the mesh and overmold mechanically interlock within the mesh spacing during molding, which provides added increased properties in the finished part. Additionally, the mesh conforms to the shape of the injection mold so that pre-forming is not required.

The exemplary assembly 300 is a grille-opening reinforcement including a crossmember 316, upper rail members 318,318 connectable to an upper rail or other component at a plurality of attachment points 322 with fasteners, and lower rail members 320,320 connectable to a lower rail or other component at a plurality of attachment points. However, any plastic/mesh hybrid assembly of any kind for a vehicle is contemplated depending upon the particular applications without departing from the scope of the present invention, including, but not limited to, front end carriers, rear carriers, instrument panel carriers, headlamp mounting cross members, grille opening reinforcements, etc.

The crossmember 316 and rails 318,320 can be integrally formed or operably connected together.

Any secondary components of any kind connectable to the assembly 300 are contemplated depending upon the particular applications without departing from the scope of the present invention, including, but not limited to, fascia, fender, headlamps, radiator, electrical components, horns, pumps, sensors, RH/LH headlamp assemblies, latches, active grille shutter, bumper, RH/LH taillight assemblies, etc.

According to another embodiment of the present invention, the method of manufacturing the plastic/mesh hybrid assembly 300 includes providing a mesh insert and providing a tool, such as an injection mold having a first half and a second half, operable to receive at least one mesh insert, manually or automated placement within a cavity of the tool, and a thermoplastic material. The mesh insert is loaded into the injection mold directly. The thermoplastic at a predetermined temperature is injected into the mold, where the mesh and overmold mechanically interlock in-mesh during molding. The mesh insert is preferably metal, most preferably, steel. The thermoplastic is selected from carbon fiber composite, polypropylene, glass reinforced polypropylene, acrylonitrile butadiene styrene, nylon, nylon glass fiber, carbon fiber reinforced polyamide, or any other thermoplastic or other material suitable for insert molding with the insert mesh component.

Alternative processes such as resistive implant welding and compression welding, incorporating the metal mesh insert, are contemplated depending on the application without departure from the scope of the present invention.

The description of the invention is merely exemplary in nature and, thus, variations that do not depart from the essence of the invention are intended to be within the scope of the invention. Such variations are not to be regarded as a departure from the spirit and scope of the invention.

What is claimed is:

1. A plastic/mesh hybrid assembly for a vehicle, comprising:
at least one insert molded mesh component located on at least one layer of the assembly in at least one predetermined area to provide increased stiffness, and
a thermoplastic overmold mechanically interlocked with the mesh of the insert molded mesh component,
wherein the insert molded mesh component mechanically interlocked with the plastic overmold adds stiffness and impact properties in the predetermined areas with increased performance criteria.

2. The plastic/mesh hybrid assembly of claim 1, wherein the assembly includes a crossmember, and the insert molded mesh component is located in the crossmember.

3. The plastic/mesh hybrid assembly of claim 2, wherein the insert molded mesh component eliminates use of metal stampings in the crossmember.

4. The plastic/mesh hybrid assembly of claim 1, wherein the insert molded mesh component is located in at least one predetermined area to add incremental stiffness over sections of the assembly without metal stampings to meet predetermined load requirements.

5. The plastic/mesh hybrid assembly of claim 1, wherein the assembly is a grille opening reinforcement including a crossmember and a pair of upper and lower rail members.

6. The plastic/mesh hybrid assembly of claim 1, wherein the assembly is selected from the group consisting of a front support crossmember, headlamp mounting crossmember, and grille opening reinforcement.

7. The plastic/mesh hybrid assembly of claim 1, further comprising at least one attachment point on the overmold for connecting at least one secondary component.

8. The plastic/mesh hybrid assembly of claim 1, wherein the at least one insert molded mesh component is positioned on an outer layer of the thermoplastic overmold.

9. The plastic/mesh hybrid assembly of claim 1, wherein the at least one insert molded mesh component is positioned in an inner layer of the thermoplastic overmold.

10. The plastic/mesh hybrid assembly of claim 1, wherein each of the insert molded mesh components are loaded directly into a mold of a tool, wherein the insert molded mesh components and thermoplastic overmold mechanically interlock in-mesh during molding.

11. The plastic/mesh hybrid assembly of claim 1, wherein the mesh component is steel.

12. The plastic/mesh hybrid assembly of claim 1, wherein the mesh component is plastic.

13. The plastic/mesh hybrid assembly of claim 1, wherein the mesh component has a mesh spacing of about grade 4 to 20 openings per inch.

14. The plastic/mesh hybrid assembly of claim 1, wherein the mesh component has an off count mesh spacing.

15. The plastic/mesh hybrid assembly of claim 1, wherein the mesh component is selected from the group consisting of plain weave, lock crimp, intermediate crimp and twill weave.

16. The plastic/mesh hybrid assembly of claim 1, wherein the mesh component is a welded mesh.

17. The plastic/mesh hybrid assembly of claim 1, wherein the mesh component has mesh that is coated.

18. The plastic/mesh hybrid assembly of claim 1, wherein the mesh component has a three dimensional geometry.

19. A plastic/metal composite assembly for a vehicle, comprising:
at least one insert molded mesh component positioned on an outer layer and/or inner layer of the assembly; and
at least one plastic composite overmold, wherein the insert molded mesh component and plastic composite overmold mechanically interlock within mesh spacing during molding providing increased stiffness and impact properties.

20. A method for making a plastic/metal composite assembly for a vehicle, comprising:
providing a thermoplastic material;
providing at least one insert molded mesh component of predetermined geometry;
providing a mold;
loading the at least one insert molded mesh component into the mold, wherein the mesh conforms to the injection mold shape without requiring a pre-form operation;
injecting the thermoplastic material into the mold forming an overmold, wherein the mesh and thermoplastic material mechanically interlock during molding providing increased properties in the assembly.
